(19) United States
(12) Patent Application Publication
(10) Pub. No.: US 2009/0197720 A1
(43) Pub. Date: Aug. 6, 2009

(54) CHAIN TENSIONER WITH COVER ELEMENT

(75) Inventors: Markus Aurhammer, Munchen (DE); Christian Bauer, Munchen (DE); Renzo Perissinotto, Dachau (DE); Tobias Lederer, Munchen (DE); Dag Heinrich, Penzing (DE)

Correspondence Address: LEYDIG VOIT & MAYER, LTD, TWO PRUDENTIAL PLAZA, SUITE 4900, 180 NORTH STETSON AVENUE, CHICAGO, IL, 60601-6731, US

(73) Assignee: IWIS MOTORSYSTEME GMBH & CO. KG, Munchen (DE)

(21) Appl. No.: 12/298,653

(22) PCT Filed: Dec. 10, 2006
(86) PCT No.: PCT/EP2006/012263

§ 371 Date: Dec. 31, 2008

(30) Foreign Application Priority Data
Apr. 28, 2006 (DE) 20 2006 006 861.9

(51) Int. Cl. F16H 7/08

(52) U.S. Cl. 474/110

(57) ABSTRACT

The present invention relates to a tensioning device for an endless drive element, in particular a timing chain of an internal combustion engine, comprising a tensioning rail which is adapted to be operatively connected to the endless drive element, and a tensioning piston which is supported in a housing in an axially displaceable manner and which presses against the tensioning rail, wherein an end face of said tensioning piston is adapted to be connected to a cap element extending beyond the tensioning piston and forming a pressure face which is in engagement with the tensioning rail.

The present invention relates to a tensioning device for an endless drive element, in particular a timing chain of an internal combustion engine, comprising a tensioning rail which is adapted to be operatively connected to the endless drive element, and a tensioning piston which is supported in a housing in an axially displaceable manner and which presses against the tensioning rail.

Such tensioning devices are used in many fields of technology. For example, timing chains in an internal combustion engine are tensioned by means of a tensioning rail. The tensioning force is here applied via a chain tensioner which presses against a suitably configured area of the tensioning rail. The chain tensioner comprises a housing which is connected to the engine block and in which a tensioning piston is guided such that it is longitudinally movable therein. The chain tensioner housing communicates with the oil supply of the engine so that an oil damping chamber formed on the back of the tensioning piston is supplied with oil. The tensioning force of the piston itself is produced hydraulically or by means of a pressure spring arranged in the oil damping chamber. In view of the prevailing pressure forces, the tensioning piston is preferably produced from a steel material, whereas the housing is produced by means of aluminium pressure die casting. There are, however, also structural designs in which a steel guide sleeve for the tensioning piston is encompassed with a thermoplastic housing by means of injection moulding.

The known tensioning devices proved to be useful in practice, but it is still endeavoured to improve them still further, especially to increase their durability without increasing the production cost. In particular, it turned out that also the contact area between the tensioning rail and the tensioning piston has to be taken into account.

For a tensioning device for an endless drive element, in particular a timing chain of an internal combustion engine, comprising a tensioning rail which is adapted to be operatively connected to the endless drive element, and a tensioning piston which is supported in a housing in an axially displaceable manner and which presses against the tensioning rail, this object is achieved in that an end face of the tensioning piston is adapted to be connected to a cap element extending beyond the tensioning piston and forming a pressure face which is in engagement with the tensioning rail.

In view of the fact that the end face of the tensioning piston is adapted to be connected to a separate element, i.e. a cap element, which is in contact with the tensioning rail, this element, which is subjected to high wear during operation, can simply be replaced without any necessity of exchanging the complete tensioning device. It also possible to use different materials for the cap element and the tensioning piston so as to achieve special characteristics when the tensioning device is in use.

According to an advantageous embodiment, the cap element of the tensioning piston can be made of plastic material. It turned out in practice that better tribological characteristics can be accomplished by the use of a cap element which is made of plastic and by the resultant contact between one contacting partner consisting of metal, i.e. the tensioning rail, and another contacting partner consisting of plastic, i.e. the cap element. In particular, the hitherto occurring wear of the piston contact point on the tensioning rail and the resultant penetration of the piston into the surface of the rail can be prevented in this way. It is thus possible to substantially reduce the wear of the tensioning device, whereby the costs will be reduced in the long run. The use of a plastic material proved to be particularly advantageous, since plastic materials are easy to process and can be chosen in accordance with the intended use and the desired characteristics.

According to a preferred embodiment, the cap element can consist of a thermoplastic, in particular a polyamide. Cap elements consisting of a thermoplastic proved to be particularly useful for the special requirements that have to be met in an internal combustion engine. Especially polyamide distinguishes itself by particularly advantageous characteristics. A cap element of the type in question can be produced at a reasonable price and it can easily be connected to the tensioning piston.

According to an advantageous embodiment, the tensioning piston can be made of metal. Tensioning pistons made of metal have been in use for a long time and they proved to be very durable. The connection between the metallic tensioning piston and the plastic cap element can easily be established and does not entail any difficulties as far as the durability of the composite tensioning piston is concerned.

According to still another preferred embodiment, the tensioning rail can consist of a metallic material, at least in the area which is engagement with the pressure face. This type of tensioning rails proved to be useful in practical use and they are known to persons skilled in the art working in this field of technology. However, the present invention is not limited to tensioning rails consisting of metal, but it can also be used advantageously in combination with a tensioning rail made of some other material, e.g. of a plastic material.

According to still another preferred embodiment of the present invention, a vent opening formed in the upper area of the tensioning piston and ending in the end face can communicate with a passage opening which extends through the cap element and ends in the pressure face of said cap element. The existence of a continuous vent opening is thus guaranteed, even if the tensioning piston is connected to the cap element, so as to guarantee continuous venting.

According to an advantageous embodiment, the diameter of the passage opening of the cap element is larger than the diameter of the vent opening of the tensioning piston. This will guarantee that a continuous vent opening is defined, even if one of the vent openings is not properly formed.

In accordance with an advantageous embodiment, the end face of the tensioning piston can have formed therein a circular recess for receiving therein the cap element. This embodiment represents a particularly simple possibility of establishing a connection between the cap element and the tensioning piston, since the cap element is here simply introduced in the recess. The cap element can additionally be fixed by means of an adhesive so as to retain it more reliably in the recess. The additional use of an adhesive is only one possibility of establishing a further connection, since it is also possible to fix the cap element by screwing or clipping it into said recess, by fitting it directly into said recess by means of injection moulding or by fastening it in some other way.

It will be of advantage when the dimensions of the cap element correspond essentially to those of the recess. According to an advantageous embodiment, the cap element can be slightly larger than the recess so that it will be held in said recess due to a tension force.

This embodiment makes additional measures, e.g. glueing, superfluous, whereby the costs will be reduced still further.

According to another preferred embodiment, the cap element can take the form of a disk. In view of the shape of the piston, it is advisable to provide a recess which is circular in shape, especially in order to simplify the production, and this results in a corresponding shape of the cap element.

It will be advantageous to accommodate two thirds of the height of the cap element in the area of the recess of the tensioning piston. One third of the height of the cap element projects beyond the end face of the tensioning piston thus forming the pressure face. A corresponding height will here suffice to avoid a contact between the tensioning piston and the tensioning rail. Simultaneously, the force retaining the cap element in the tensioning piston will be increased, since a sufficiently large part of the cap element is here introduced in the tensioning piston so that an unintentional disengagement of the cap element from the tensioning piston can be excluded.

According to another preferred embodiment, the cap element can have formed therein a recess for accommodating an area which is associated with the end face of the tensioning piston. Also in this case it is advisable to implement both the cap element and the recess such that they are circular in shape. Other than in the case of the preceding embodiment, where the cap element was introduced in the tensioning piston, the cap element is attached onto the tensioning piston in accordance with the present embodiment. Also this embodiment can be produced and serviced easily and it allows an easy replacement of the cap element. This embodiment proved to be useful, since the shape of the conventional tensioning piston remains unchanged.

It will be advantageous when the end face of the tensioning piston abuts on the bottom of the recess, and when the circular peripheral portion constituting part of the cap element and formed through said recess contacts the outer wall of the tensioning piston which borders directly on the end face. As has already been described, the cap element is attached onto the tensioning piston; in so doing, the bottom of the recess is brought into contact with the end face of the tensioning piston, thus guaranteeing that the cap element properly fits on the tensioning piston. The cap element is here held in position through the peripheral portion which is formed by the recess and which encompasses the outer wall of the tensioning piston. Said peripheral portion also defines a protective element for protecting the tensioning piston against wear.

It will be of advantage when the height of the peripheral portions corresponds to at least half the height of the cap element. These dimensions proved to be useful in practice for guaranteeing that the cap element is securely held on the tensioning piston.

According to an advantageous embodiment, the recess formed in the cap element can have a diameter which is slightly smaller than that of the end face of the tensioning piston. When a cap element having this kind of structural design is attached to the tensioning piston, said cap element can be held on the tensioning piston through the prevailing pressure conditions.

According to another preferred embodiment, the pressure face can be provided with a circumferentially bevelled edge. This will prevent wear of the edge and, simultaneously, improve the contact between the pressure face and the tensioning rail.

According to an advantageous embodiment, the tensioning piston and the cap element can be connected to one another by a positive connection, or a non-positive or frictional connection. These methods proved to be useful in practice and can be exchanged arbitrarily, e.g. with due regard to the concretely used materials, so as to achieve a good and stable connection.

In the following, one embodiment of the present invention will be explained in detail, making reference to a drawing, in which:

FIG. 1 shows a top view of a tensioning piston having the cap element inserted therein;

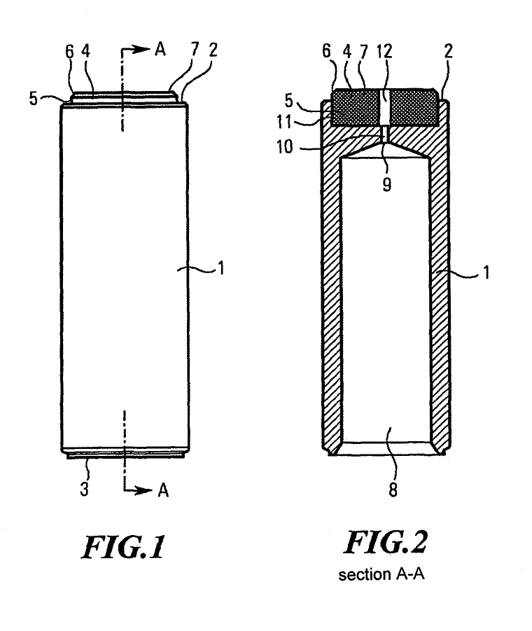

FIG. 2 shows the tensioning piston according to FIG. 1, in a sectional view along line A-A of FIG. 1;

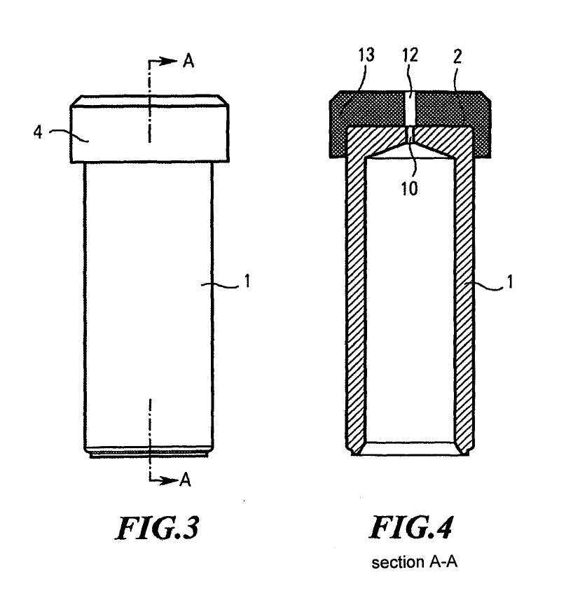

FIG. 3 shows a top view of a tensioning piston having the cap element attached thereto, and

FIG. 4 shows the tensioning piston according to FIG. 3, in a sectional view along line A-A of FIG. 3.

In FIG. 1 a conventional tensioning piston 1 is implemented such that it comprises an end face 2 as well as a face 3 which is opposed to said end face 2. When the chain tensioner is in operation, a tensioning piston of this type is introduced in a housing such that the end face 2 projects beyond the housing.

The end face 2 of the tensioning piston 1 has inserted therein a cap element 4. The cap element 4 extends beyond the end face 2 and comprises a peripheral area 5 extending beyond the end face 2, a bevelled edge 6 as well as the pressure face 7, i.e. the face which is formed parallel to the end face 2 of the tensioning piston and which presses against the tensioning rail when the chain tensioner is in use.

The exact structural design of the tensioning piston as well as of the cap element 4 can clearly be seen from FIG. 2, which shows a sectional view. As has already been known, the tensioning piston 1 is provided with a coaxial bore 8 into which a guide pin is inserted when the chain tensioner is in use. The bore is provided with a conical end in the vicinity of the end face 2. A vent opening 10 extends from the apex 9 of the conical end of the bore 8 up to and into the end face 2.

The end face is provided with a circular recess so that, in the present case, the vent opening 10 extends up to and into the bottom of the recess.

The cap element 4 is inserted in said recess so as to fully occupy said recess. Reference numeral 11 designates the part of the cap element arranged within the recess. It can clearly be seen that approximately two thirds of the height of the cap element 4 are accommodated in the recess and that only one third extends beyond the end face 2 of the tensioning piston. The cap element is here circular in shape and made of plastic material, in particular of a polyamide.

The cap element has centrally formed therein a passage opening 12 which extends through the full height of the cap element 4 and which is centrally arranged in the latter. The diameter of the passage opening 12 is slightly larger than the diameter of the vent opening 10. In the assembled condition, the passage opening 12 is arranged directly above the vent opening 10 so that a continuous opening between the bore 8 of the tensioning piston and the pressure face 7 of the cap element is guaranteed. Since the diameter of the passage opening 12 is larger than that of the vent opening 10, an unproblematic connection between the two openings is here guaranteed.

FIG. 3 shows again a conventional tensioning piston 1; in the area of the end face, a cap element 4 is attached onto the tensioning piston and surrounds part of the outer wall of said tensioning piston. In the description following hereinbelow, in particular in the description relating to FIG. 4, identical parts of the tensioning piston and of the cap element are provided with reference numerals corresponding to those used in FIGS. 1 and 2.

The structural design of the tensioning piston corresponds to that of the tensioning piston described in FIGS. 1 and 2 and will not be described here once more.

Other than the cap element according to FIGS. 1 and 2, the cap element according to this embodiment is attached onto the tensioning piston, as can in particular be clearly seen from FIG. 4, and surrounds an area of the outer wall of the tensioning piston. The cap element has here a diameter which is larger than that of the tensioning piston 1 and it is provided with a recess for inserting therein the end face 2 of the tensioning piston and an area of the outer wall thereof. The end face 2 abuts here on the bottom of the recess of the cap element 4. Also the attached cap element 4 is provided with a passage opening 12 so as to guarantee that the vent opening 10 of the tensioning piston 1 continues in the cap element 4.

The recess in the cap element 4 extends at least over half the height of the cap element so that the height of the peripheral portion 13, which is defined by the recess, corresponds to at least half the height of the entire cap element 4. This guarantees that the cap element is securely held on the tensioning piston.

1-17. (canceled)

18. A tensioning device for an endless drive element, in particular a timing chain of an internal combustion engine, comprising a tensioning rail which is adapted to be operatively connected to the endless drive element, a tensioning piston (1) which is supported in a housing in an axially displaceable manner and which presses against the tensioning rail, and a cap element (4) extending beyond the tensioning piston (1) and forming a pressure face (7) which is in engagement with the tensioning rail, wherein an end face (2) of the tensioning piston (1) being adapted to be connected to the cap element (4), characterized in that the end face (2) of the tensioning piston (1) has formed therein a recess with a bottom for accommodating the cap element (4).

19. A tensioning device according to claim 18, characterized in that the cap element (4) of the tensioning piston (1) is made of plastic material.

20. A tensioning device according to claim 18, characterized in that the cap element (4) consists of a thermoplastic, in particular a polyamide.

21. A tensioning device according to claim 18, characterized in that the tensioning piston (1) is made of metal.

22. A tensioning device according to claim 18, characterized in that the tensioning rail consists of a metallic material, at least in the area which is in engagement with the pressure face (7).

23. A tensioning device according to claim 18, characterized in that a vent opening (10) formed in the upper area of the tensioning piston (1) and ending in the end face (2) is connectable to a passage opening (12) which extends through the cap element (4) and ends in the pressure face (7) of said cap element (4).

24. A tensioning device according to claim 23, characterized in that the diameter of the passage opening (12) of the cap element (4) is larger than the diameter of the vent opening (10) of the tensioning piston (1).

25. A tensioning device according to claim 18, characterized in that the dimensions of the cap element correspond at least to those of the recess of the tensioning piston (1) and that, in particular, they are slightly larger than those of said recess.

26. A tensioning device according to claim 18, characterized in that the cap element (4) takes the form of a disk.

27. A tensioning device according to claim 18, characterized in that two thirds of the height of the cap element (4) are accommodated in the area of the recess of the tensioning piston (1).
